(19) United States
(12) Patent Application Publication
(10) Pub. No.: US 2009/0238140 A1
(43) Pub. Date: Sep. 24, 2009

(54) Gateway apparatus and handover method

(75) Inventor: Yuji Kojima, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED

(21) Appl. No.: 12/314,883

(22) Filed: Dec. 18, 2008

(30) Foreign Application Priority Data
Mar. 21, 2008 (JP) 2008-73227

(51) Int. Cl. H04W 36/00

(52) U.S. Cl. 370/331

(57) ABSTRACT

A gateway apparatus for exchanging packet between a home agent and a mobile station, and being a destination gateway apparatus to which the mobile station is connected by handover, having a transmission unit which transmits to the home agent a simultaneous registration request requesting simultaneous registration of a bi-directional tunnel at both an old route via a source gateway apparatus to which the mobile station is connected before handover, and a new route via the destination gateway apparatus; and a packet control unit which discards one downlink packet of a duplicated downlink packet addressed to the mobile station, when the simultaneous registration is maintained.

### CROSS-REFERENCE TO RELATED APPLICATIONS

This application is based upon and claims the benefit of priority of the prior Japanese Patent Application No. 2008-73227, filed on Mar. 21, 2008, the entire contents of which are incorporated herein by reference.

### FIELD

The present invention relates to a gateway apparatus and a handover method.

### BACKGROUND

In recent years, the IEEE (Institute of Electrical and Electronic Engineers) has been working ongoingly in the standardization of WiMAX (Worldwide Interoperability for Microwave Access), which is a wireless communication scheme (see, for instance, IEEE 802.16e-2005. WiMAX extended to mobile stations is referred to also as “mobile WiMAX”).

FIG. 10 is a diagram illustrating a network configuration example of a WiMAX-based mobile communication system 100. The mobile communication system 100 has a home agent (HA) 120; access service network gateways (ASN-GWs, hereinafter “gateways”) 130, 140; base stations (BS) 150, 160; and a mobile station (MS) 170. The home agent 120 and the two gateways 150, 160 are connected to one another. The MS and BS are specified in IEEE 802.16e-2005. ASN-GW is specified in “WiMAX Forum Network Architecture Stage 2/3 Release 1 Version 1.2”, 11 Jan. 2008. HA is governed by Mobile IP (hereinafter “MIP”) (for instance, as in “IP Mobility Support for IPv4” RFC3344, August 2002).

In the example illustrated in FIG. 10, the mobile station 170 is depicted moving (handover) from being covered by the base station 150 to being covered by the base station 160. The numerals in brackets denote the route sequence of the packets being exchanged.

Specifically, when the mobile station 170 is under the base station 150, packets are exchanged with the home agent 120 via the base station 150 and the source gateway 130 (route (1)). The destination gateway 140 carries out exchange of handover-request messages and so forth with the source gateway 130, and temporarily buffers the packets received from the home agent 120 via the source gateway 130 (route (2)). Thereafter, when the mobile station 170 actually moves on under the coverage of the base station 160, the destination gateway 140 sends the buffered packets and receives packets from the mobile station 170. The mobile station 170 exchanges packets with the home agent 120 via the source gateway 130 (route (3)). With an appropriate timing, the destination gateway 140 issues a formal registration to the home agent 120 (post-registration), and switches the route, whereupon the mobile station 170 exchanges packets with the home agent 120 via the destination gateway 140 (route (4)).

Switching from route (3) to route (4) is done on condition that the switching timing is the timing estimated by the destination gateway 140 when there are no packets on route (3). For instance, should packets not be exchanged for a given time, it is estimated that there are no packets on route (3).

However, when it is not possible to find out the timing at which there are no packets on route (3), or when the timing estimation is erroneous, there exists the possibility of loss of uplink packets (hereinafter “UL packets”) residing in route (3) when the destination gateway 140 switches to route (4).

To prevent packet loss during such a handover, there is a conventional technology called simultaneous registration (Simultaneous Binding) (see, for instance, “Simultaneous Bindings for Mobile IPv6 Fast Handovers <draft-elmaki-mobileip-bicasting-v6-0.6txt>”, July 2005). In simultaneous registration, the home agent 120 is requested simultaneous registration of a bi-directional tunnel (a state in which both uplink and downlink transmission of UL packets and DL packets is possible) between the source and destination gateways 130, 140 and the home agent 120. As a result, a reverse tunnel (state in which UL packets can be transmitted to the home agent 120) can be maintained between the source and destination gateways 130, 140 and the home agent 120, thereby preventing UL packet loss.

Japanese Patent Application Laid-open No. 2006-246481 discloses another technology for preventing packet loss during handover.

However, the home agent 120 copies and sends downlink packets (hereinafter “DL packets”), when simultaneous registration is carried out. That is, the home agent 120 sends the DL packets via route (3) and the copied DL packets via route (4). As a result, the mobile station 170 receives overlappingly two identical DL packets via route (3) and route (4).

In Japanese Patent Application Laid-open No. 2006-246481, a PAR (Previous Access Router: equivalent to the source gateway 130 in FIG. 10) sends a transmission complete notification message (flush message) to a NAR (New Access Router; the destination gateway 140 in FIG. 10). This takes into account only DL packets, but not the UL packets reaching the PAR from the NAR. Therefore, there exists the possibility of loss of UL packets residing between the NAR and the PAR when routes are switched as described above.

Even if route (3) is switched to route (4) by post-registration, the distances in the two routes are different, and hence the mobile station 170 receives the DL packets via route (4) earlier than via route (3), which gives rise to the problem of reception of DL packets having an inverted order.

### SUMMARY

In the light of the above problems, it is an object of the present invention to provide a gateway apparatus, and a handover method, in which packet loss is prevented.

Another object of the present invention is to provide a gateway apparatus and so forth in which packet order inversion is prevented.

Furthermore, another object of the present invention is to provide a gateway apparatus and so forth in which duplicated reception of packets is prevented.

To achieve the above-described objects, according to one embodiment of the present invention, a gateway apparatus for exchanging packet between a home agent and a mobile station, and being a destination gateway apparatus to which the mobile station is connected by handover, has a transmission unit which transmits to the home agent a simultaneous registration request requesting simultaneous registration of a bi-directional tunnel at both an old route via a source gateway apparatus to which the mobile station is connected before handover, and a new route via the destination gateway apparatus; and a packet control unit which discards one downlink packet of a duplicated downlink packet addressed to the mobile station, when the simultaneous registration is maintained.

Additionally, to achieve the above-described objects, according to another embodiment of the present invention, a handover method in a gateway apparatus for exchanging packets between a home agent and a mobile station, and being a destination gateway apparatus to which the mobile station is connected by handover, the method has the steps of transmitting to the home agent a simultaneous registration request requesting simultaneous registration of a bi-directional tunnel at both an old route via a source gateway apparatus to which the mobile station is connected before handover, and a new route via the destination gateway apparatus; and discarding one downlink packet of a duplicated downlink packet addressed to the mobile station, when the simultaneous registration is maintained.

The present invention succeeds in providing a gateway apparatus and a handover method in which packet loss is prevented. The present invention succeeds also in providing a gateway apparatus and so forth in which packet order inversion is prevented. The present invention succeeds moreover in providing a gateway apparatus and so forth in which duplicated reception of packets is prevented.

Additional objects and advantages of the invention (embodiments) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating a network configuration structure example of a mobile communication system;

FIG. 2 is a diagram illustrating a configuration example of the destination gateway;

FIG. 3 is a sequence diagram illustrating a hand over operation example;

FIG. 4 is a sequence diagram illustrating a hand over operation example;

FIG. 5 is a diagram illustrating a configuration example of the gateways and the home agent;

FIG. 6 is a sequence diagram illustrating a handover operation example;

FIG. 7 is a sequence diagram illustrating a handover operation example;

FIG. 8 is a sequence diagram illustrating a handover operation example;

FIG. 9 is a sequence diagram illustrating a handover operation example; and

FIG. 10 is a diagram illustrating a network configuration example of a conventional mobile communication system.

### DESCRIPTION OF EMBODIMENTS

Preferred embodiments of the present invention are explained below with reference to accompanying drawings.

### Embodiment 1

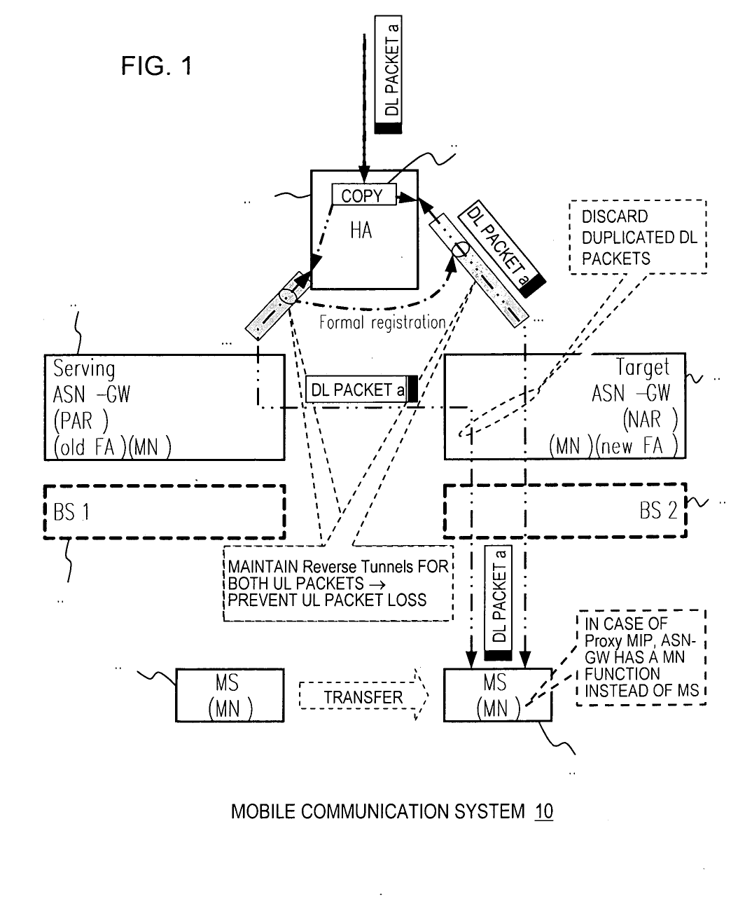

Embodiment 1 will be explained first. FIG. 1 is a diagram illustrating a network configuration structure example of a mobile communication system 10 according to Embodiment 1. The mobile communication system 10 has a home agent (HA) 20; two gateway apparatuses (serving ASN-GW, target ASN-GW, hereinafter “gateways”) 30, 40; two base stations (BS1, BS2) 50, 60; and a mobile station 70.

The two gateways 30, 40 have also the function of FA (foreign agent) governed by the MIP protocol, and of AR (access router) governed by a fast MIP protocol. The mobile station 70 has also the function of MN (mobile node) governed by the MIP protocol. In the case where the network is controlled under a proxy MIP protocol, the two gateways 30, 40 have the function of MN governed by the Mobile IP protocol.

The home agent 20 is a router at the network to which the mobile station 70 is to be connected. The home agent 20 is connected to the two gateways 30, 40, and also to a backbone gateway. During simultaneous registration (Simultaneous Binding), the home agent 20, which has a copy unit 21, transmits DL packets from a backbone gateway to the gateway 30, and transmits DL packets copied by the copy unit 21 to the gateway 40.

The two gateways 30, 40, which are connected to each other, manage a plurality of respective base stations. In the present embodiment, the gateways 30, 40 manage base stations 50, 60, respectively.

The two base stations 50, 60 are connected to the gateways 30, 40, respectively, transmits DL packet outputted from the gateway 30, 40 to the mobile station 70, and outputs UL packets outputted from the mobile station 70 to the gateway 30, 40.

The mobile station 70 communicates wirelessly to the base station 50, 60, receives DL packet, and transmits UL packet.

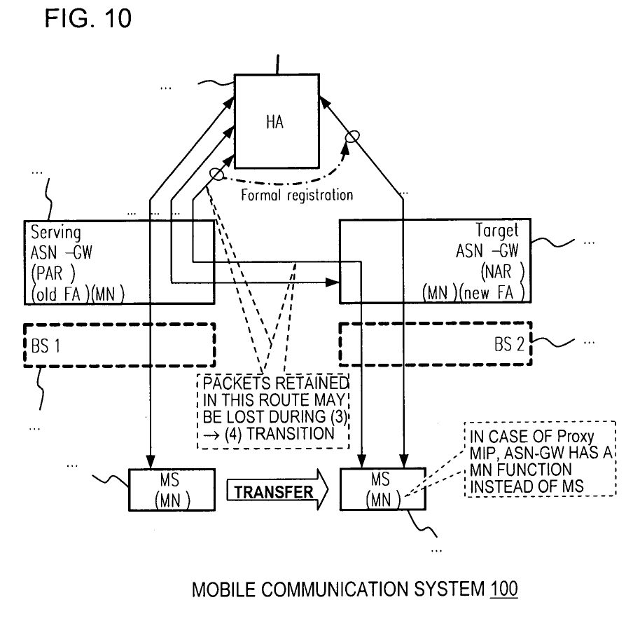

The example illustrated in FIG. 1 is an example in which the mobile station 70 is handed over from the base station 50 to the base station 60. In the figure, the dashed double-dotted line represents the route of the packets. In the example illustrated in FIG. 1, the operations of route (1) and route (2) illustrated in FIG. 10 have been already performed. Hereinafter, the gateway 30 will be referred to as the source gateway (or serving gateway (Serving ASN-GW)) and the gateway 40 will be referred to as the destination gateway (or target gateway (Target ASN-GW)).

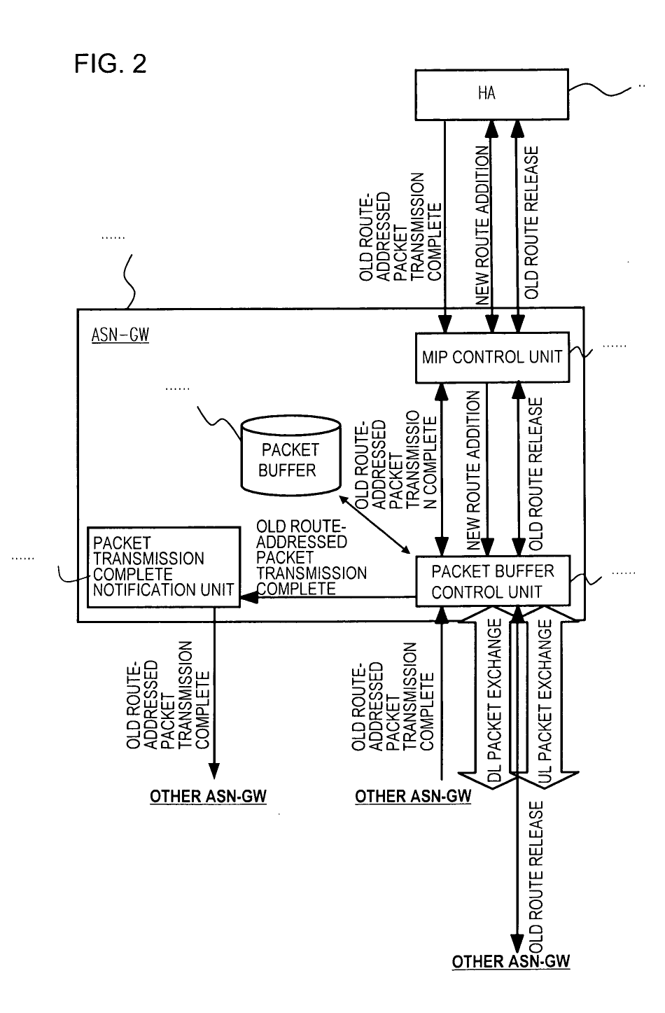

FIG. 2 is a diagram illustrating a configuration example of the destination gateway 40. The source gateway 30 has the same configuration as the destination gateway 40. The destination gateway 40 (30) has a MIP control unit 41 (31), a packet buffer control unit 42 (32), a packet buffer 43 (33) and a packet transmission complete notification unit 44 (34).

The MIP control unit 41 generates a new route addition request message and an old route release request message, and exchanges these messages with the home agent 20. The MIP control unit 41 transmits the old route release request to other gateways (for instance, the source gateway 30) via the packet buffer control unit 42.

The packet buffer control unit 42, exchanges UL packets and DL packets with the home agent 20, the base stations 50, 60 and other gateways (for instance, the source gateway), and writes and reads packets to and from the packet buffer 43, as the case may require. In accordance with the state of the packet buffer 43, the packet buffer control unit 42 instructs the packet transmission complete notification unit 44 to issue an old route-addressed packet transmission complete notification. The packet buffer control unit 42 receives the old route-addressed packet transmission complete notification from another gateway, and outputs the notification to the MIP control unit 41.

The packet buffer 43 stores DL packets and UL packets, under the control of the packet buffer control unit 42.

The packet transmission complete notification unit 44 generates the old route-addressed packet transmission complete notification, on the basis of the instruction from the packet buffer control unit 42, and transmits the notification to another gateway (source gateway 30 or the like).

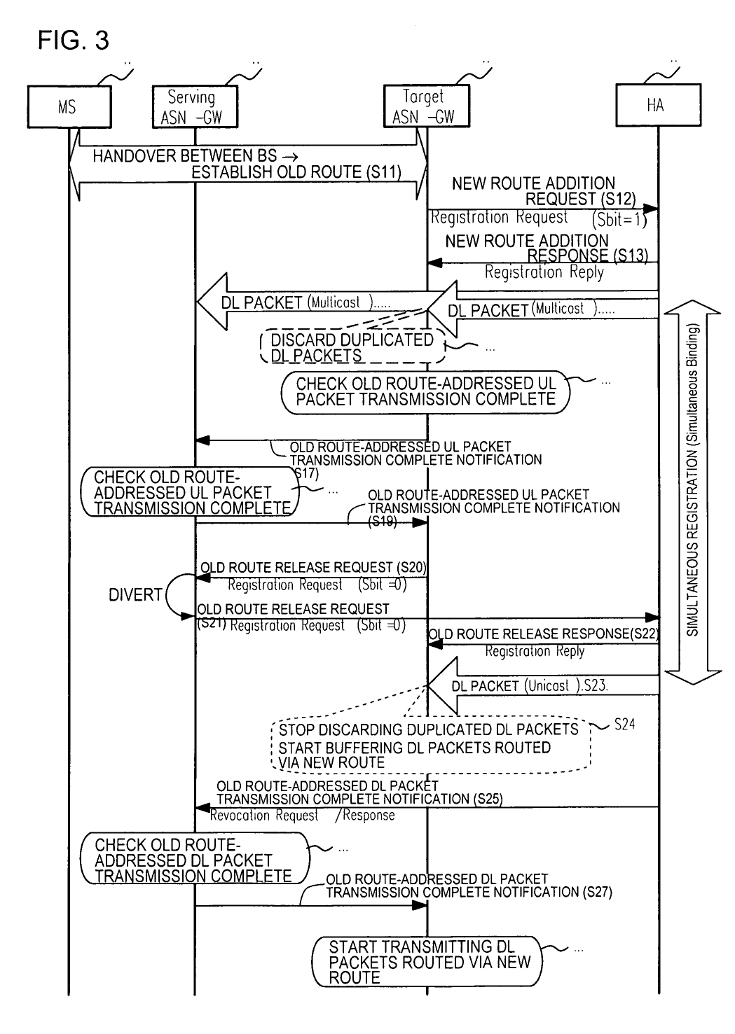

The handover operation of the mobile communication system 10 is explained next. FIG. 3 is a sequence diagram illustrating an operation example of the mobile communication system 10 in Embodiment 1. The operation example is an operation example after the mobile station 70 has actually moved on under the coverage of the base station 60. A bi-directional tunnel is maintained between the source gateway 30 and the home agent 20.

Firstly, the destination gateway 40 establishes an old route (in the present example, route (3)) between the destination gateway 40 and the mobile station 70 (S11).

Next, the destination gateway 40 sends a new route addition request (Registration Request) for a new route (in the present example, route (4)) to the home agent 20 (S12). This new route addition request is accompanied by simultaneous registration (Simultaneous Binding) (Sbit=1). For instance, the MIP control unit 41 generates the request and sends it to the home agent 20.

Next, the destination gateway 40 receives a new route addition response (Registration Reply) from the home agent 20 (S13). Thereby, the bi-directional tunnel is maintained simultaneously not only between the source gateway 30 and the home agent 20, but also between the destination gateway 40 and the home agent 20. For instance, the MIP control unit 41 receives the response, and outputs the response to the packet buffer control unit 42.

Next, the destination gateway 40 receives DL packets from the home agent 20 via the new route (route (4)) (S14). The source gateway 30 as well receives the DL packets from the home agent 20 (S14). For instance, the packet buffer control units 32, 42 receive the DL packets.

Upon receiving the DL packets from the home agent 20, the destination gateway 40 discards the DL packets (S15), to prevent duplicated packets from being sent to the mobile station 70. For instance, the packet buffer control unit 42 discards the DL packets received by the new route from the time at which the new route addition response (S13) is inputted from the MIP control unit 41. Since, for instance, the DL packets include route information (or information on whether or not the DL packet is copied), or since the receiving interface differs for the new route or the old route, the packet buffer control unit 42 can identify the DL packets of the new route and can easily discard the DL packets. Of course, the packet buffer control unit 42 may discard the old route DL packets instead of the new route DL packets.

Next, the destination gateway 40 checks completion of transmission of UL packets addressed to the old route (s16). That is, the destination gateway 40 checks that there are held no UL packets to be sent (UL packets to be sent to the source gateway 30) on route (3).

For instance, the packet buffer control unit 42 accesses the packet buffer 43, and checks that there are stored no UL packets sent by the old route, i.e. route (3). For instance, the packet buffer control unit 42 confirms UL packet transmission completion when UL packets cannot be read from a certain storage area of the packet buffer 43 where the UL packets are stored. Alternatively, the packet buffer control unit 42 stores in the packet buffer 43, together with the UL packets, a flag indicating the UL direction, and confirms UL packet transmission completion by checking that no such flag is stored in the packet buffer 43.

Upon confirming completion of transmission of UL packets addressed to the old route, the destination gateway 40 sends an old route-addressed UL packet transmission complete notification to the source gateway 30 (S17). For instance, the packet buffer control unit 42 outputs a completion notification instruction to the packet transmission complete notification unit 44, whereupon the latter sends the old route-addressed UL packet transmission complete notification.

Next, the source gateway 30 checks completion of transmission of UL packets addressed to the old route (S18). The source gateway 30 checks that no UL packets to be sent to route (3) (UL packets to be sent to the home agent 20) are still held. For instance, the packet buffer control unit 32 of the source gateway 30 accesses the packet buffer 33 and checks whether there are any stored UL packets. This check follows the same process of S16.

Upon confirming transmission completion, the source gateway 30 sends an old route-addressed UL packet transmission complete notification to the destination gateway 40 (S19). For instance, the packet buffer control unit 32 outputs a completion notification instruction to the packet transmission complete notification unit 34, whereupon the latter outputs the old route-addressed UL packet transmission complete notification to the destination gateway 40.

The purpose of the processing from S16 to S19 is to confirm that there are no UL packets residing in route (3). In the processing of S16, the destination gateway 40 checks that there are no UL packets to be sent to the source gateway 30, while in the processing of S18, the source gateway 30 checks that there are no UL packets to be sent to the home agent 20. As a result, there are no UL packets residing in route (3), and packet loss can be prevented in that UL packets residing in route (3) do not reach the home agent 20, when the route is switched only to route (4).

Upon receiving from the source gateway 30 the old route-addressed UL packet transmission complete notification (S19), the destination gateway 40 sends a release request (Registration Request (Sbit=0)) to the source gateway 30 (S20) for releasing the old route (route (3)). For instance, upon receiving the notification, the packet buffer control unit 42 outputs the notification to the MIP control unit 41, whereupon the MIP control unit 41 generates the release request message, and sends the release request message to the source gateway 30 via the packet buffer control unit 42.

Next, upon receiving the release request, the source gateway 30 sends the received release request to the home agent 20 (S21). For instance, upon receiving the release request, the packet buffer control unit 32 outputs the release request to the MIP control unit 31, and the MIP control unit 31 sends the release request to the home agent 20.

Thus, the destination gateway 40 sends the old route release request to the home agent 20 not directly, but via (diversion) the source gateway 30 (S20 to S21). Since route (4) has a shorter distance than route (3), in the case where the destination gateway 40 sends the release request directly to the home agent 20 there is a possibility that UL packets residing in route (3) reach the home agent 20 after the release request has reached the home agent 20. The purpose of the diversion is to avoid such an occurrence. Loss of UL packets residing in the old route (route (3)) is thus reliably prevented by diverting the release request so as to track (without overtaking) the UL final packet that is transmitted via the old route.

Next, the destination gateway 40 receives an old route release response (Registration Reply) from the home agent 20 (S22). As a result, only the new route (route (4)) of the two bi-directional tunnels maintained by simultaneous registration is maintained now. For instance, the MIP control unit 41 receives the old route release response and outputs it to the packet buffer control unit 42.

Next, the destination gateway 40 stops discarding the DL packets of the new route (route (4)) being discarded theretofore, and buffers the DL packets in the packet buffer 43 (S23, S24). Discarding of DL packets addressed to the new route is now discontinued because in the processing of S22 the old route is released and there is only maintained the bi-directional tunnel of the new route, so that the problem of duplicated transmission of DL packet does not arise. For instance, the packet buffer control unit 42 stores the DL packets received from the home agent 20 in the packet buffer 43.

Next, the source gateway 30 receives from the home agent 20 an old route-addressed DL packet transmission complete notification (Revocation Request/Response) (S25). For instance, when the home agent 20 checks that no DL packets to be sent are held in the old route (route (3)), the home agent 20 sends the notification. The MIP control unit 31 of the source gateway 30 receives the notification and sends it to the packet buffer control unit 32.

Next, the source gateway 30 checks that no old route DL packets are held (S26). For instance, the packet buffer control unit 32 accesses the packet buffer 33 and checks that there are stored no DL packets to be sent via the old route.

Next, the source gateway 30 sends the old route-addressed DL packet transmission complete notification to the destination gateway 40 (S27). For instance, when the packet buffer control unit 32 confirms that no old route DL packets are stored in the packet buffer 33, the packet buffer control unit 32 sends the old route-addressed DL packet transmission complete notification to the destination gateway 40 via the packet transmission complete notification unit 34.

Next, the destination gateway 40 sends the DL packet stored in the packet buffer 43 to the base station 60 (S28). If the destination gateway 40 sends to the base station 60 the DL packets transmitted by the new route (route (4)) after old route release (after S23), there exists the possibility that the DL packets residing in the old route (route (3)) reach the destination gateway 40 later than the DL packets transmitted via the new route (route (4)). That is, there exists the possibility of sending inverted-order DL packets. Therefore, the destination gateway 40 stores in the packet buffer 43 the DL packets transmitted via the new route (route (4)) until receiving all the DL packets residing in route (3) (S24). After confirming that there are no DL packets residing in the old route (route (3)) (S27), the destination gateway 40 sends the DL packets transmitted via the new route (route (4)). As a result, the destination gateway 40 sends DL packets without order inversion to the mobile station 70, so that the mobile station 70 can receive DL packets without order inversion.

This concludes the above series of processes. From then on the mobile station 70 exchanges packets with the destination base station 60.

Thus, the destination gateway 40 discards new route DL packets (S15 to S24) while bi-directional tunnels are maintained by simultaneous registration between the gateways 30, 40 and the home agent 20. As a result, the mobile station 70 does not receive duplicated DL packets.

Also, both gateways 30, 40 check completion of transmission of UL packets addressed to the old route, and send the diverted release request to the home agent 20 (S16 to S22). Packet loss of UL packets residing in the old route (route (3)) can be prevented thereby.

Moreover, the destination gateway 40 buffers the new route DL packets (S24 to S28), and hence the mobile station 70 does not receive order-inverted DL packets.

The above-described processes of Embodiment 1 are carried out in the source and destination gateways 30, 40, and hence the embodiment can be realized without adding new functions to the home agent 20.

### Embodiment 2

Embodiment 2 is explained next. The configurations of the network of the mobile communication system 10 and of the gateways 30, 40 are identical to those of Embodiment 1 (FIGS. 1 and 2). The present Embodiment 2 is an example in which a message based on Embodiment 1 is mapped to a message used by so-called WiMAX (inter-gateway tunnel-release message). As a result, the mobile communication system 10 can perform handover using a WiMAX-compliant communication scheme.

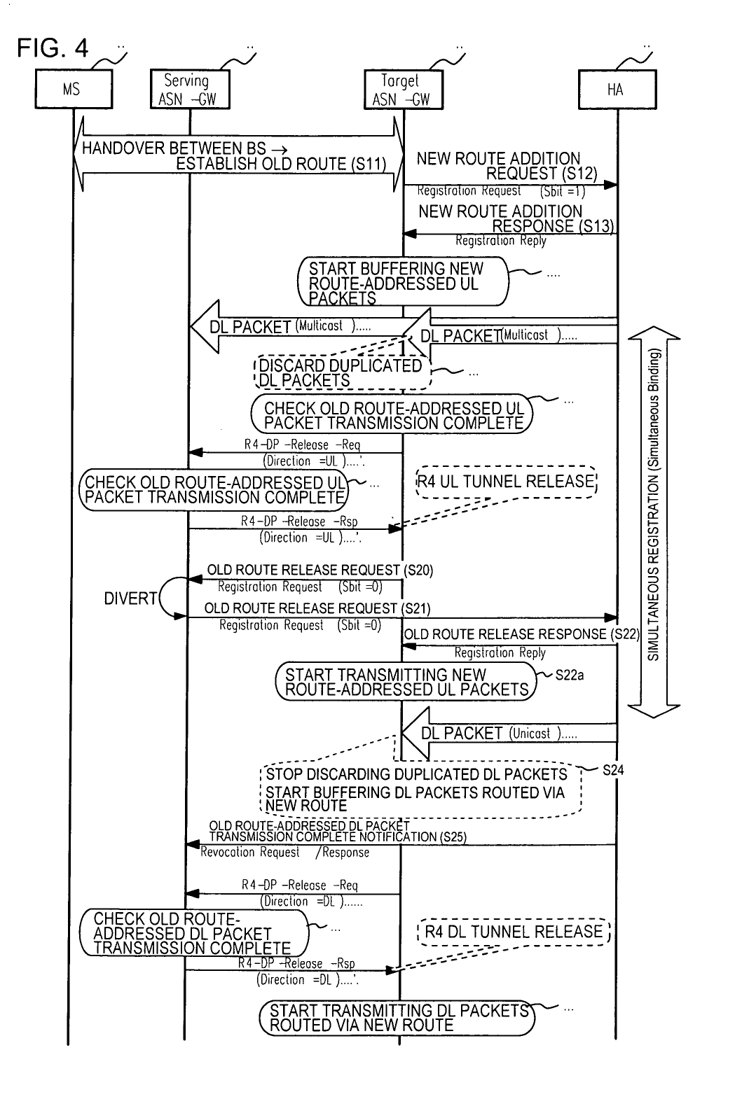

FIG. 4 is a sequence diagram illustrating an operation example of the mobile communication system 10 in Embodiment 2. In the present Embodiment 2, the old route-addressed UL packet transmission complete notification (S17,S19) and the old route-addressed DL packet transmission complete notification (S27) described in Embodiment 1 are performed using tunnel-release messages (R4-DP-Release-Req, R4-DP-Release-Rsp) defined in WiMAX. Herein, “R4” is the denomination of an interface between gateways.

Specifically, the destination gateway 40 sends an uplink-direction tunnel-release request message (R4-DP-Release-Req (Direction=UL)) (S17′). This tunnel-release request message has superimposed thereon the meaning of “old route-addressed UL packet transmission complete notification” (S17 of Embodiment 1), and is thus used as that notification in Embodiment 2.

The source gateway 30 sends, to the destination gateway 40, a response message (R4-DP-Release-Rsp (Direction=UL)) responding to the notification (S19′). The tunnel response message is used also as the “old route-addressed UL packet transmission complete notification” (S19 in Embodiment 1).

The destination gateway 40 sends a DL tunnel release request message (R4-DP-Release-Req (Direction=DL)) requesting that the source gateway 30 sends the old route-addressed DL packet transmission complete notification as a DL tunnel release request response message (S25a). The source gateway 30 sends to the destination gateway 40 the DL tunnel release response message (R4-DP-Release-Rsp (Direction=DL)) as the response message (old route-addressed DL packet transmission complete notification) (S27′).

The packet buffer control units 42, 32 generate these tunnel release request messages and send them to the gateways 30, 40, via the packet transmission complete notification units 44, 34.

Upon receiving the new route addition response from the home agent 20 (S13), the destination gateway 40 stores the UL packets addressed to the new route (route (4)) in the packet buffer 43 (S13a), while upon receiving the old route release response from the home agent 20 (S22), the destination gateway 40 sends the UL packets to the home agent 20 via the new route (S22a), so that, in the process from S13a to S22a, bi-directional tunnels are maintained for both the new route and the old route, and UL packets are sent to the home agent 20 without packet order inversion. For instance, the packet buffer control unit 42 performs buffer control of the UL packets.

### Embodiment 3

Embodiment 3 is explained next. Embodiment 3 is an example in which the home agent 20 buffers UL packets routed via the new route.

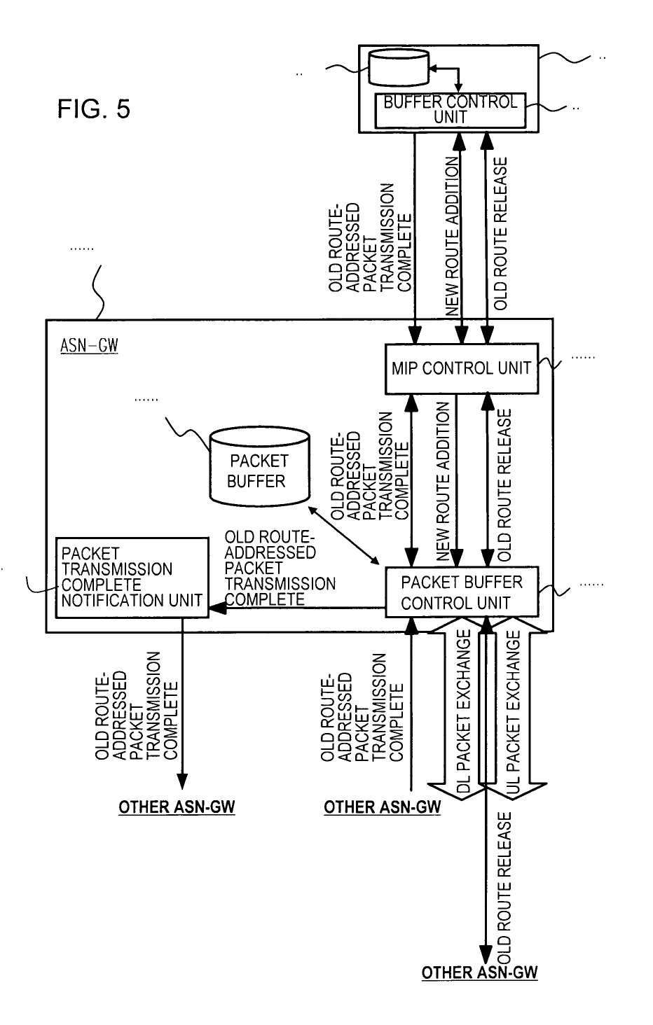

FIG. 5 is a diagram illustrating a configuration example of the gateways 30, 40 and the home agent 20 of Embodiment 3. The home agent 20 has a buffer 22 and a buffer control unit 23.

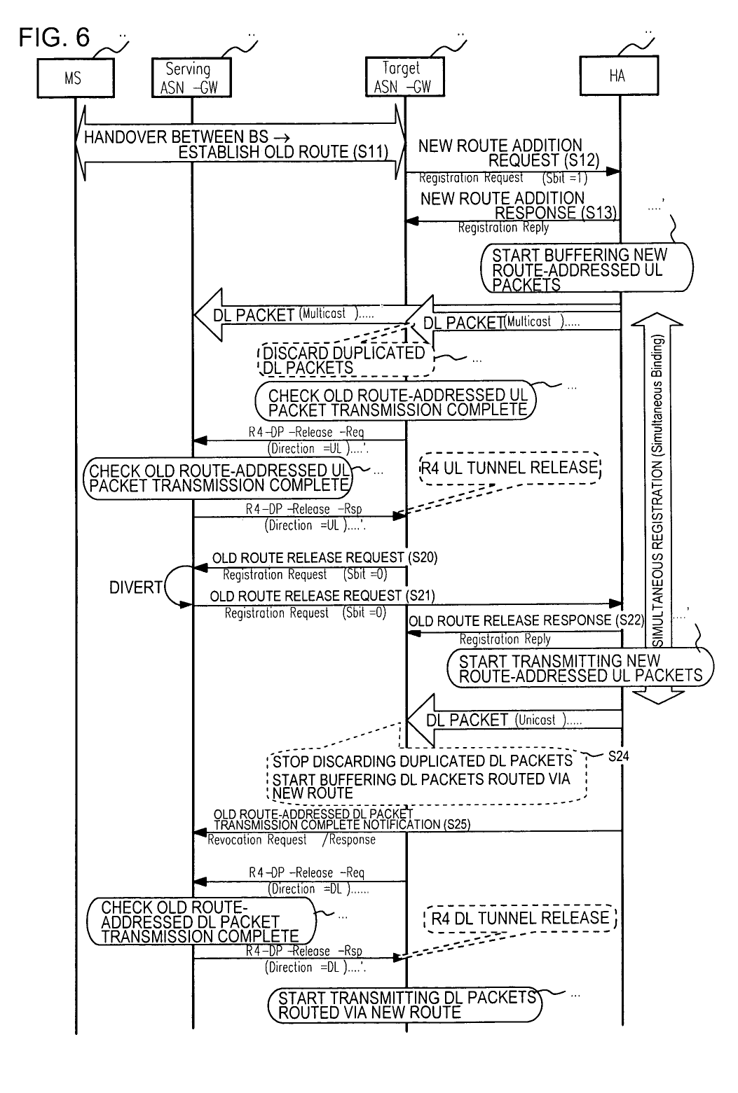

FIG. 6 is a sequence diagram illustrating a handover operation example according to Embodiment 3. Triggered by the new route addition (S12, S13), the home agent 20 initiates buffering of UL packet routed via the new route (S13a′). For instance, the buffer control unit 23 stores in the buffer 22 the UL packets from the time at which the buffer control unit 23 transmits the new route addition response.

Triggered by the old route release (S22) indicating that there are no residing UL packets in the old route, the buffer control unit 23 in the home agent 20 initiates transmission of the buffered UL packets (S22a′).

In the present Embodiment 3, the home agent 20 buffers the UL packets, and the destination gateway 40 buffers the DL packets (S24, S28), sharing thus packet storage. This allows reducing as a result buffer size in the destination gateway 40.

### Embodiment 4

Embodiment 4 is explained next. Embodiment 4 is an example in which UL packets addressed to the new route (route (4)) and DL packets routed via the new route are not buffered but sent as soon as the packets become transmittable.

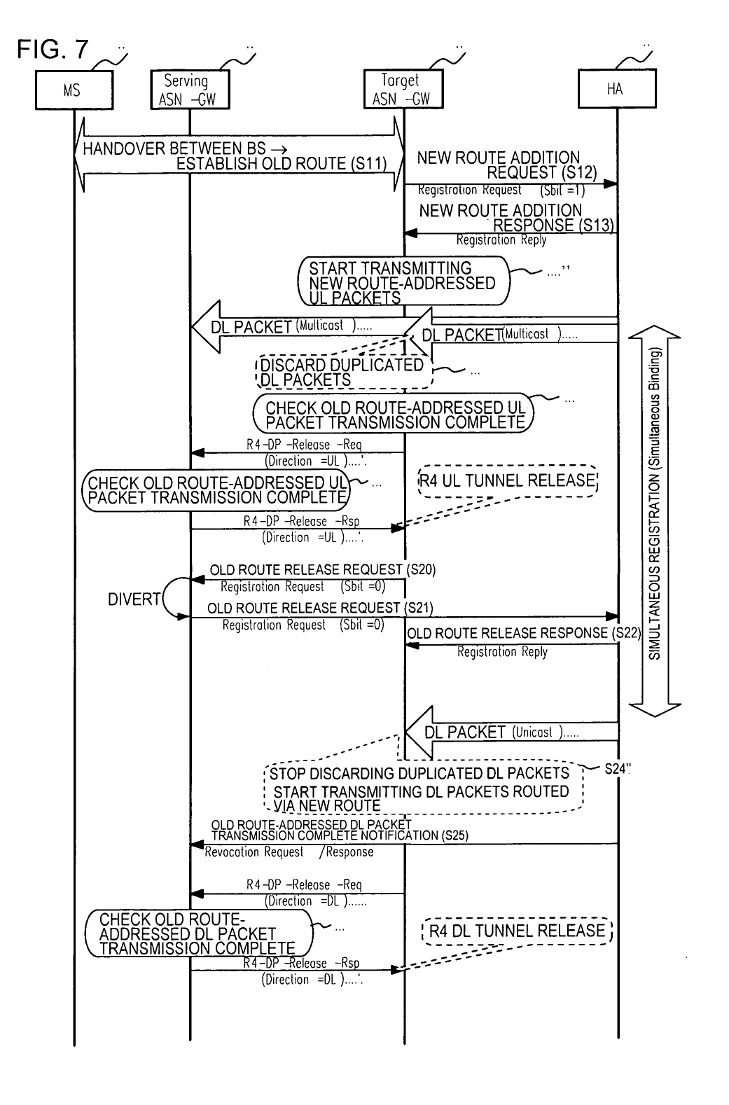

FIG. 7 is a sequence diagram illustrating a handover operation example according to Embodiment 4. Processes identical to those of Embodiment 2 (FIG. 4) and so forth are denoted with identical reference numerals. Upon receiving the new route addition response (S13), the destination gateway 40 sends to the home agent 20 the UL packet addressed to the new route, without buffering the UL packet (S13a″).

Upon receiving the old route release response (S22), the destination gateway 40 stops discarding duplicated DL packets and sends to the base station 60 the DL packets routed via the new route (route (4)) (S24″). This is done for instance in the packet buffer control unit 42.

In Embodiment 2, the destination gateway 40 buffers the UL packets and the DL packets (S13a, S24 in FIG. 4) to prevent packet order inversion. However, jitter characteristics degrade on account of packet buffering. Jitter characteristics are an indicator of inter-packet delay variance. Depending on the used application (for instance, real-time video and audio), it may be preferable to improve jitter rather than packet order inversion. In Embodiment 4, the destination gateway 40 transmits the packets immediately, without packet buffering. This allows improving jitter characteristics.

### Embodiment 5

Embodiment 5 is explained next. Embodiment 5 is an example in which the destination gateway 40 and the source gateway 30 share a security context that is required for message authentication.

An Authentication Extension field, for checking counterfeiting of a transmission-source IP address, is added to the MIP protocol message. This field cannot be generated in the absence of an encryption key. Message authentication is carried out in the destination gateway 40 and the home agent 20, which beforehand share an encryption key. Therefore, the destination gateway 40 can send, for instance, the new route addition request (S12) directly to the home agent 20. However, the source gateway 30, which is a transmission source different from the transmission source of the new route addition request, does not share with the home agent 20 security information such as the encryption key that is shared by the destination gateway 40 and the home agent 20. Accordingly, the source gateway 30 cannot send, directly to the home agent 20, the release request message corresponding to the new route addition request sent by the destination gateway 40. In Embodiment 5, therefore, the source gateway 30 and the destination gateway 40 share a security context.

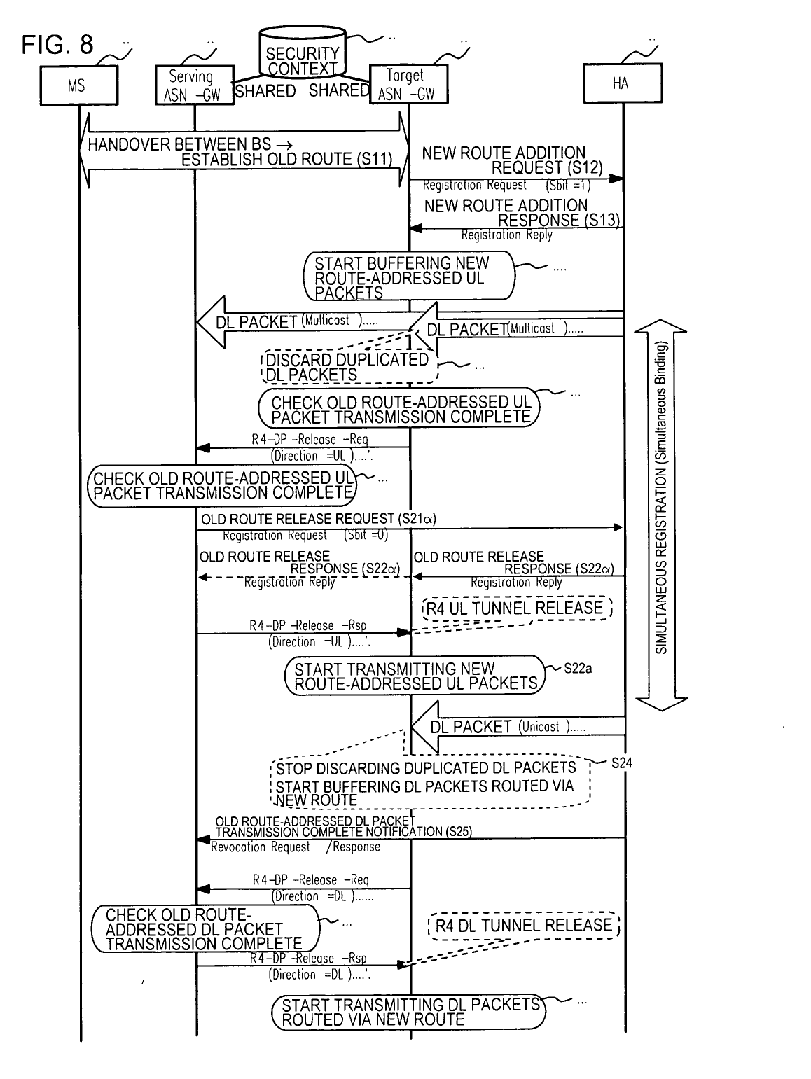

FIG. 8 is a sequence diagram illustrating an example of handover according to Embodiment 5. Processes identical to those of Embodiment 1 and so forth are denoted with identical reference numerals. In Embodiment 1 and so forth, the old route release request (Registration Request (Sbit=0)) is diverted by the destination gateway 40 (S20, S21 in FIG. 3 or the like). In Embodiment 5, the source gateway 30 sends the old route release request directly to the home agent 20 (S21α). The source gateway 30 sends this request with its source address set to the destination gateway 40. In response to this request, the home agent 20 sends the old route release response (Registration Reply) to the destination gateway 40 (S22a). The destination gateway 40 forwards the response to the source gateway 30.

Next, the source gateway 30 requests tunnel release between the source gateway 30 and the destination gateway 40 (S19′).

The security context, for instance, includes security information (such as an encryption key) for authentication, and is stored in a memory of the MIP control units 41, 31 (FIG. 2). The processes of S21α, S22α are carried out, for instance, in the MIP control units 41, 31.

As an alternative way, the destination gateway 40 need not forward the old route release response (S22α) to the source gateway 30. That is because the destination gateway 40 may send the UL packets addressed to the new route with the timing with which the destination gateway 40 receives the response from the home agent 20, and thus the source gateway 30 does not imperatively require information of the response.

The destination gateway 40 may initiate transmission of UL packets addressed to the new route when triggered by either S22α or S19′. That is because the destination gateway 40 can detect completion of transmission of UL packets addressed to the old route on the basis of either S22α or S19′.

In Embodiment 5, the destination gateway 40 can send the old route release request without diverting the latter. Also, both the source and destination gateways 30, 40 complete transmission of UL packets addressed to the old route (S16, S18), whereafter the source gateway 30 requests old route release to the home agent 20 (S21α). In Embodiment 5, therefore, both packet order inversion and UL packet loss can be prevented, as is the case in Embodiment 1 and so forth, without the old route release request overtaking the final UL packet routed through the old route.

### Embodiment 6

Embodiment 6 is explained next. Embodiments 1 to 5 have been explained as examples of the Proxy MIP protocol. The Proxy MIP protocol is a protocol according to which the gateways 30, 40 assume as proxies the function of the MN of the mobile station 70 (function of carrying out exchange of messages on the basis of the MIP protocol). Embodiment 6 is an example of a client MIP in which the mobile station 70 has the MN function.

During handover, the mobile station 70 is aware of packet exchange via the home agent 20 and the destination gateway 40 alone, without awareness of inter-gateway tunnels between the source gateway 30 and the destination gateway 40. It is thus not realistic for the mobile station 70 to be involved in release of tunnels between the gateways, or in simultaneous registration from the gateways 30, 40, which are the endpoints of the inter-gateway tunnels. Message exchange for simultaneous registration, therefore, is assumed by the destination gateway 40, which rewrites route switching requests from the mobile station 70. The mobile station 70 cannot see simultaneous registration being carried out between the gateways 30, 40 and the home agent 20.

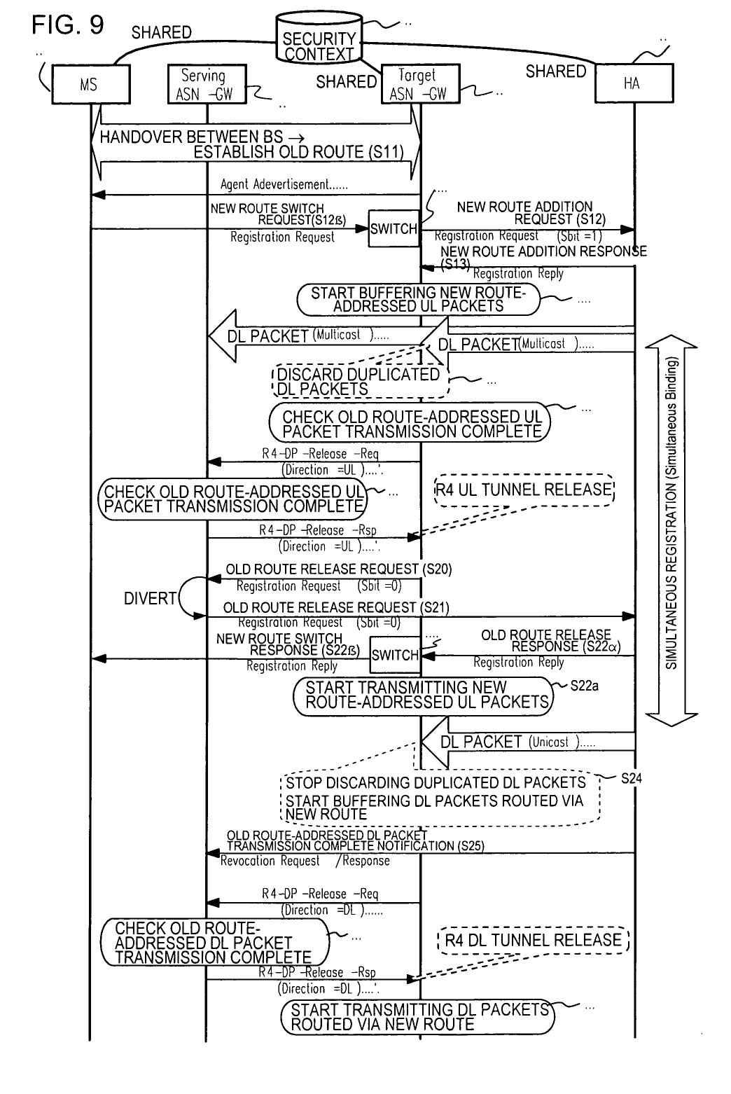

FIG. 9 is a sequence diagram illustrating a handover operation example according to Embodiment 6. Processes identical to those of Embodiment 1 and so forth are denoted with identical reference numerals. The mobile station 70, the destination gateway 40 and the home agent 20 share a security context 80 (Embodiment 5). As in Embodiment 5, the MIP control unit 41, the mobile station 70 and the home agent 20 hold the security context 80 beforehand.

The destination gateway 40 sends an Agent Advertisement to the mobile station 70 (S11β). For instance, the MIP control unit 41 generates the message and sends it to the mobile station 70 via the packet buffer control unit 42.

The mobile station 70 receives the message and detects thereby a new FA (=destination gateway 40). The mobile station 70 sends a route switching request (Registration Request (without Sbit field)) requesting switching to a route via the new FA (S12β).

Next, the destination gateway 40 rewrites the received route switching request to the new route addition request (Registration Request (Sbit=1)) and sends the latter to the home agent 20 (S12). The MIP control unit 41 carries out this processing.

Thereafter, upon receiving from the home agent 20 the old route release response (Registration Reply) (S22β), the destination gateway 40 rewrites the old route release response to a route switching response (Registration Reply), and sends the latter to the mobile station 70 (S22β). Rewriting is performed by the MIP control unit 41, and the response is sent to the mobile station 70 via the packet buffer control unit 42.

The mobile station 70 simply sends the route switching request (S12β) and receives the route switching response (S22β). Therefore, the mobile station 70 simply confirms that the old route has been switched to the new route.

The mobile station 70 can thus be realized in the same way as in Embodiment 1 and so forth, also in the case of being a client MIP provided with a MIP.

The above features can be summarized in the claims below.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A gateway apparatus for exchanging packet between a home agent and a mobile station, and being a destination gateway apparatus to which the mobile station is connected by handover, comprising:
a transmission unit which transmits to the home agent a simultaneous registration request requesting simultaneous registration of a bi-directional tunnel at both an old route via a source gateway apparatus to which the mobile station is connected before handover, and a new route via the destination gateway apparatus; and
a packet control unit which discards one downlink packet of a duplicated downlink packet addressed to the mobile station, when the simultaneous registration is maintained.

2. The gateway apparatus according to claim 1, wherein the transmission unit sends to the source gateway apparatus a release request for the old route so as not to overtake an uplink final packet routed via the old route.

3. The gateway apparatus according to claim 1, wherein the transmission unit sends an inter-gateway tunnel release message to the source gateway apparatus to notify thereby the source gateway apparatus of completion of transmission of the packet routed via the old route.

4. The gateway apparatus according to claim 1, further comprising a packet buffer;
wherein the packet control unit stores in the packet buffer the downlink packet and a uplink packet addressed to the home agent.

5. The gateway apparatus according to claim 1, further comprising a packet buffer;
wherein the packet control unit stores the downlink packet in the packet buffer, and
a uplink packet addressed to the home agent is stored in the home agent.

6. The gateway apparatus according to claim 1, wherein the packet control unit stops discarding the downlink packet when there is no uplink packet on the old route.

7. The gateway apparatus according to claim 1, wherein the packet control unit transmits immediately the packet to the home agent or the mobile station, without storing the packet, when the packet become transmittable via the new route.

8. The gateway apparatus according to claim 1, wherein the source gateway apparatus, being different from the gateway apparatus transmitting the simultaneous registration request, sends to the home agent a release request for the old route so as not to overtake an uplink final packet routed via the old route.

9. The gateway apparatus according to claim 1, wherein the transmission unit rewrites the route switching request to the simultaneous registration request and sends the simultaneous registration request to the home agent, upon reception of a route switching request from the mobile station, and rewrites a release response to a route switching response for the route switching request and sends the route switching response to the mobile station, upon reception from the home agent of the release response for the old route

10. The gateway apparatus according to claim 6, further comprising a packet buffer;
wherein the packet control unit stops discarding the downlink packet and stores in the packet buffer the downlink packet to be transmitted via the new route until there is no the downlink packet in the old route.

11. The gateway apparatus according to claim 10, wherein the packet control unit starts transmitting the downlink packet stored in the packet buffer to the mobile station, after there is no the downlink packet in the old route.

12. The gateway apparatus according to claim 1, wherein the simultaneous registration request is included in a new route addition request requesting the home agent to add the new route.

13. The gateway apparatus according to claim 12, wherein the packet buffer control unit initiates the discarding from the time at which the packet buffer control unit receives from the home agent a new route addition response for the new route addition request.

14. The gateway apparatus according to claim 1, wherein the packet buffer control unit discards either the downlink packet from the old route or the downlink packet from the new route.

15. The gateway apparatus according to claim 8, wherein the source gateway apparatus shares identical security information relating to the home agent with the destination gateway apparatus.

16. A handover method in a gateway apparatus for exchanging packets between a home agent and a mobile station, and being a destination gateway apparatus to which the mobile station is connected by handover, the method comprising the steps of:
transmitting to the home agent a simultaneous registration request requesting simultaneous registration of a bi-directional tunnel at both an old route via a source gateway apparatus to which the mobile station is connected before handover, and a new route via the destination gateway apparatus; and
discarding one downlink packet of a duplicated downlink packet addressed to the mobile station, when the simultaneous registration is maintained.
